(19) United States
(12) Patent Application Publication
(10) Pub. No.: US 2011/0145163 A1
(43) Pub. Date: Jun. 16, 2011

(54) PROVISION OF SELLER PROFILE

(76) Inventors: Narendra Kumar Kurra, Livermore, CA (US); Vasanth Myilsamy, Palayam (IN); Naresh Cheedella, (US)

(21) Appl. No.: 12/638,901

(22) Filed: Dec. 15, 2009

(51) Int. Cl. G06Q 10/00; G06Q 30/00

(52) U.S. Cl. 705/347

(57) ABSTRACT

In an example embodiment, a method is provided for providing a profile of a seller. In this method, a request from a computing device inquiring about the profile of the seller of an item is received. A category and/or price of the item are identified. Information from transactions associated with the seller is retrieved from a data structure using the category and/or prices as the filtering criteria. A metric is then calculated based on the information from the previous transactions and thereafter, a response to the request with the metric is provided to the computing device.

### FIELD

The present disclosure relates generally to information retrieval. In an embodiment, the disclosure relates to the provision of a seller profile.

### BACKGROUND

Sellers can list various items for sale on the Internet. Potential buyers of the items may not be familiar with the sellers to purchase the items. Accordingly, many electronic commerce services provide ratings of the sellers. However, such ratings are typically simple ratings of the sellers that range, for example, from zero (low rating) to a five (high rating) by all the previous buyers who have purchased from the sellers.

### BRIEF DESCRIPTION OF DRAWINGS

The present disclosure is illustrated by way of example and not limitation in the figures of the accompanying drawings, in which like references indicate similar elements and in which:

FIG. 1 is a block diagram depicting an example of a system, within which embodiments of the present invention may be deployed;

FIG. 2 is a block diagram showing the various modules included in a computing device for providing profiles of sellers, in accordance with an example embodiment of the present invention;

FIG. 3 is a flow diagram of a general overview of a method, in accordance with an embodiment of the present invention, for providing a profile of a seller;

FIG. 4 is a user interface diagram, in accordance with an embodiment, that shows how a profile of a particular seller can be invoked or displayed;

FIG. 5 is another user interface diagram, in accordance with an embodiment, that provides a profile of a seller;

FIG. 6 is a flow diagram of a general overview of another method, in accordance with an alternate embodiment, for providing additional information with the metrics;

FIG. 7 is a user interface diagram showing a user interface, in accordance with an alternate embodiment, for providing a profile of a seller that includes metrics as well as other additional information; and

FIG. 8 is a block diagram of a machine in the example form of a computing device within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

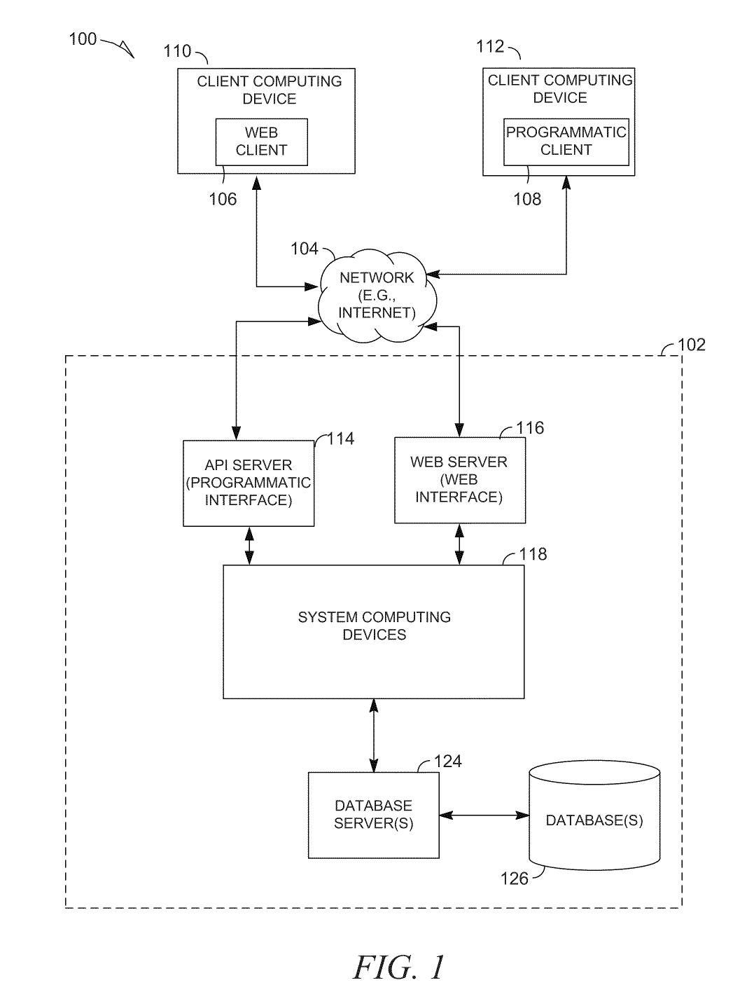

The embodiments described herein provide various techniques for providing profiles of sellers. When an item is listed by a seller, a system can provide a detailed profile of the seller to, for example, a potential buyer. In one embodiment, such a profile can be based on information from previous transactions by that seller, as explained in more detail below. FIG. 1 is a block diagram depicting an example of a system 100, within which embodiments of the present invention may be deployed. The system 100 includes client computing devices 110 and 112 in communication with a networked system 102 by way of a network 104. The networked system 102, in the example form of a network-based publication or marketplace system, may provide server-side functionality by way of the network 104 (e.g., the Internet or Wide Area Network (WAN)) to one or more clients, such as a web client 106 (e.g., a browser) and a programmatic client 108 executing on client computing devices 110 and 112, respectively.

A module interface 114 (e.g., an Application Program Interface (API) server) and a web interface 116 (e.g., a web server) are communicatively coupled to, and provide interfaces to, system computing devices 118. The system computing devices 118 are configured to host one or more modules that, as explained in more detail below, provide profiles of one or more sellers. The system computing devices 118 are, in turn, communicatively coupled to one or more database servers 124 that facilitate access to one or more databases 126.

In various embodiments, the system computing devices 118 may provide a number of marketplace functions and services to users that access the networked system 102. For example, the system computing devices 118 may provide payment services, online auction services, electronic commerce services, advertisement services, and other services.

The programmatic client 108 may access the various services and functions provided by the system computing devices 118 by way of the module interface 114. In some example embodiments, the programmatic client 108 may allow a user operating the client computing device 112 to originate online publications. The online publications may be of any type, including, for example, online publications for advertisements and auction item listings. For example, programmatic client 108 may be a seller application (e.g., TurboLister application developed by eBay Inc., of San Jose, Calif.) to enable sellers to author and manage listings on the networked system 102 in an off-line manner, and to perform batch-mode communications between the programmatic client 108 and the networked system 102.

On the other hand, the web client 106 may access the system computing devices 118 by way of the web interface 116. For some embodiments, a user of the client computing device 110 may use the Web client 106 to view online publications (e.g., advertisements or listings) originated by a user of the client computing device 112 and/or originated by other sources. In an example embodiment, the user of the client computing device 110 may view, via the Web client 106, profiles of sellers, as described in more detail below.

It should be appreciated that while the system 100 shown in FIG. 1 employs a client-server architecture, the present subject matter is, of course, not limited to such an architecture, and could equally well find application in a distributed, or peer-to-peer, architecture system, for example.

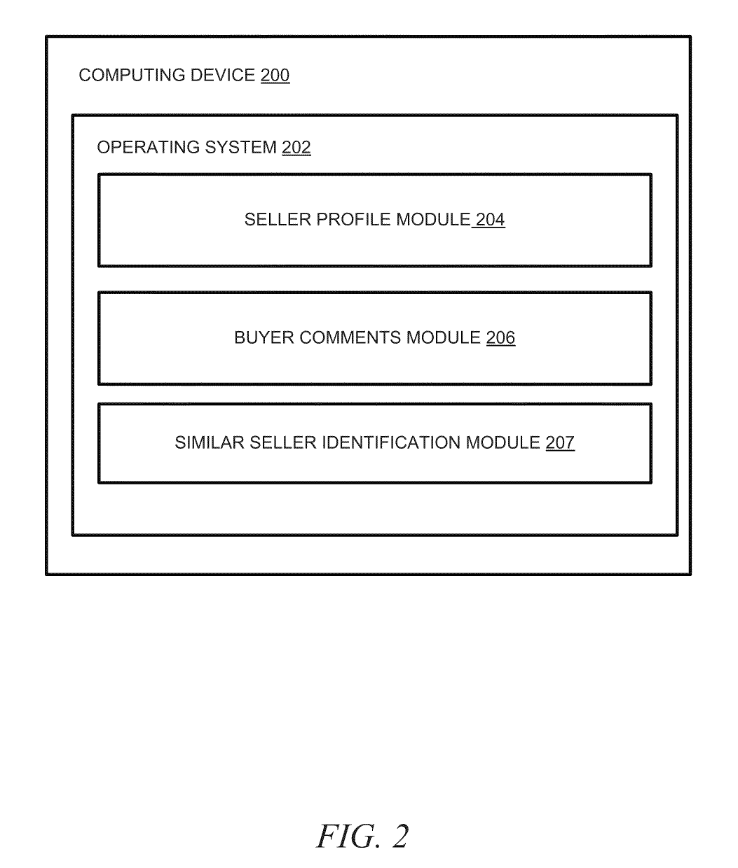

FIG. 2 is a block diagram showing the various modules included in a computing device 200 for providing profiles of sellers, in accordance with an example embodiment of the present invention. It should be appreciated that the computing device 200 may be deployed in the form of, for example, a personal computer, a laptop computer, a server computer, a tablet personal computer, or other computing devices. The computing device 200 may be included in a networked system. For example, the computing device 200 may form a part of the system computing devices 118 depicted in FIG. 1. Returning to FIG. 2, in various embodiments, the computing device 200 may be used to implement computer programs, logic, applications, methods, processes, or software to provide profiles of sellers, as explained in more detail below.

In the example depicted in FIG. 2, the computing device 200 executes an operating system 202 that manages software processes and/or services executing on the computing device 200. In one embodiment of the present invention, these software processes and/or other services include a seller profile module 204, a buyer comments module 206, and a similar seller identification module 207.

The seller profile module 204 is configured to receive requests from, for example, client computing devices inquiring about profiles of sellers. A profile of a seller refers to characteristics or an evaluation of the characteristics of the seller. Various metrics may be used to define such a profile and, as described in more detail below, these metrics are based on information from previous transactions associated with the sellers. Upon receipt of the requests, the seller profile module 204 calculates such metrics and provides them as responses to the requests.

The buyer comments module 206, on the other hand, is configured to display buyer feedbacks associated with the sellers. As used herein, “buyer feedback” refers to a response to a particular transaction with a seller. An example of a buyer feedback is a message or comment from a buyer describing his experience with transacting with the seller. As explained in more detail below, the buyer feedbacks may be displayed together with the metrics, in accordance with one embodiment. In addition to buyer feedbacks, other similar sellers may also be displayed together with the metrics. Here, the similar seller identification module 207 is configured to identify and display other similar sellers with the metrics, as also described in more detail below.

It should be appreciated that in other embodiments, the computing device 200 may include fewer, more, or different modules apart from those shown in FIG. 2. For example, the computing device 200 may not host a buyer comments module 206 because, in an alternate embodiment, buyer feedbacks may not be displayed with the metrics. In yet another embodiment, the computing device 200 may not host the similar seller identification module 207 because, for example, similar sellers may not be listed or displayed with the metrics.

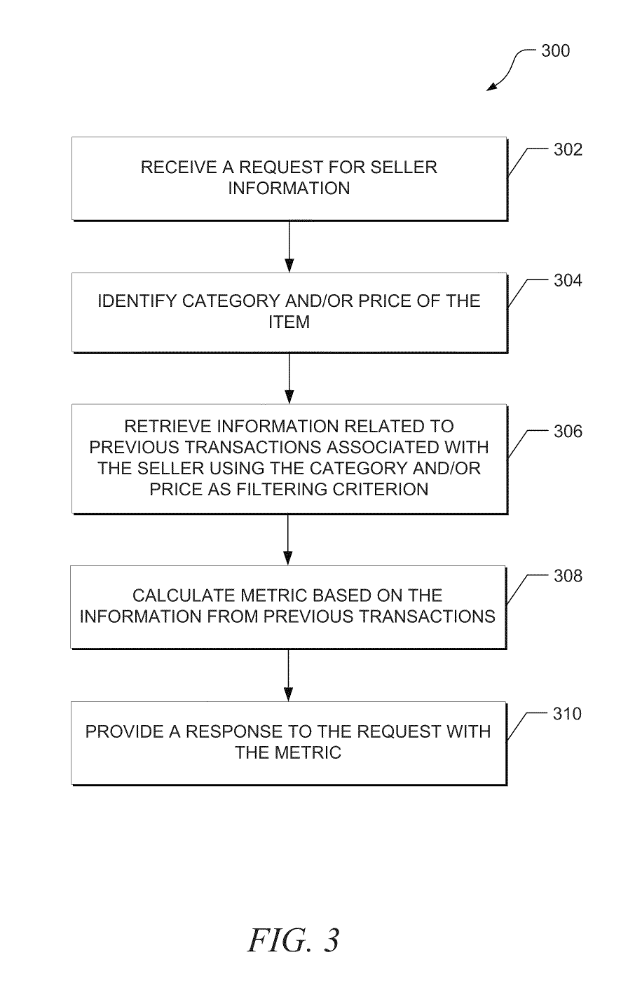

FIG. 3 is a flow diagram of a general overview of a method 300, in accordance with an embodiment of the present invention, for providing a profile of a seller. In an embodiment, the method 300 may be implemented by the seller profile module 204 and employed in the computing device 200 of FIG. 2. In the example of FIG. 3, a user may be interested in purchasing or acquiring an item listed at an electronic commerce service or Website. An “item,” as used herein, includes any tangible or intangible thing and/or something that has a distinct, separate existence from other things (e.g., goods, services, electronic files, and land). Before making the purchase, the user may want to know about the profile of the seller of the particular item at interest. To view the profile of the seller, the user of a client computing device may, for example, make a selection at a user interface to display the profile. As a result of the selection, the client computing device may transmit a request to, for example, a server inquiring about the profile.

As depicted in FIG. 3, the request inquiring about the profile is received at 302. It should be appreciated that the request may, for example, be an Hypertext Transfer Protocol (HTTP) request, which is an HTTP message asking for information. Examples of HTTP requests include “GET,” “POST,” or other instructions. Upon receipt of the request, one or more attributes of the particular item at interest are identified at FIG. 3. An “attribute,” as used herein, refers to a quality belonging to an item, which may, for example, be defined in a title assigned to an item or defined in a description associated with the item. Examples of attributes include size, shape, color, construction material, country of manufacture, brand name, category assigned to the item, serial number, price, discount, and other attributes. In one embodiment, a category of the particular item is identified. A “category,” as used herein, refers to a class or division, in any general scheme of item classification. In another embodiment, the price of the particular item is identified. In yet another embodiment, both the category and the price of the particular item are identified.

With the category and/or price, information from previous transactions associated with the seller is retrieved at 306 from, for example, a data structure using the category and/or price as filtering criteria. A “previous transaction,” as used herein, refers to a record of a listing that was previously submitted by the seller. A record can include descriptions and a variety of different attributes associated with the item. Accordingly, information from previous transactions can include colors, categories, and prices of items listed by the seller before the current listing. In other examples, information can include a count of the attributes, a count of the previous transactions themselves, buyer feedbacks, and other information. Such information can be stored in a data structure. In general, a data structure provides context for the organization of data. Examples of data structures include tables, arrays, linked lists, databases, and other data structures.

In one embodiment, the information from the previous transactions associated a seller are retrieved using the category and/or price as filtering criteria. As used herein, a “filtering criteria” refers to a search criteria. For example, the filtering criteria can be specified in a query. A filtering criteria can be a string that may include field references, operators (e.g., mathematical, comparison, logical, and reference operators), and constants. The retrieval of the information may include searching for information from previous transactions of items that are assigned to the same category as the current item. As an example, to retrieve information from only previous transactions where items are assigned to a category named “toy,” the filtering criteria may be “category=toy.”

In another example, the retrieval of information may include searching for information from previous transactions of items with the same price range as the current item. Here, the price of the current item is previously identified, and a price range can be predefined. In one example, to retrieve information from only previous transactions where items are priced between ±10% of the price X, the filtering criteria can be defined as “0.20>X>0.10.” In another example, to retrieve information from only previous transactions where items' prices are between $60 and $100, the filtering criteria may be “>60 and <100.”

After the information is retrieved, one or more metrics can be calculated based on the information at 308. A “metric,” as used herein, refers a profile of a seller defined or stated in quantifiable terms. For example, a metric can be a mathematical algorithm that describes a profile of a seller. It should be appreciated that a variety of different metrics may be calculated. For example, as explained in more detail below, metrics related to positive feedbacks of the seller, repeated purchases, and successful listings may be calculated. The calculated metric can then be provided in a response to the request at 310. For example, the response may be an HTTP response, which is an HTTP message generated in response to an HTTP request, that includes the calculated metric. Upon receipt of the response, the client computing device that transmitted the request, for example, can display the metric at a video display unit to provide the profile of the seller.

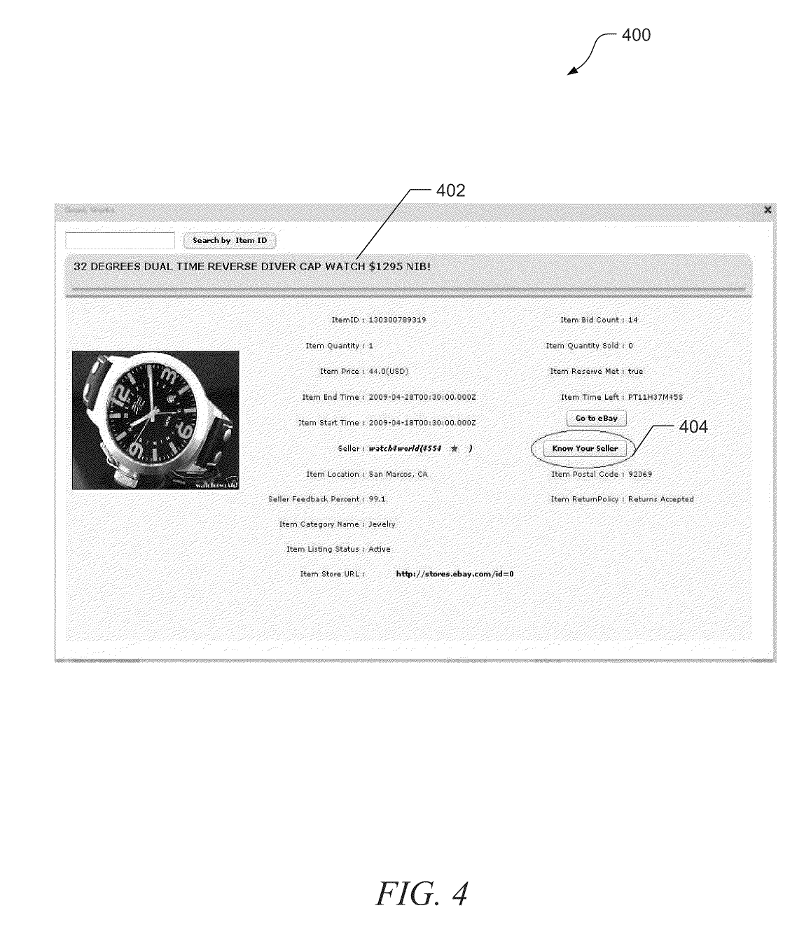

FIG. 4 is a user interface diagram, in accordance with an embodiment, that shows how a profile of a particular seller can be invoked or displayed. As depicted, a user interface 400 includes a main window region 402 that shows various information about an online auction of a particular item. The main window region 402 includes a button region “Know Your Seller” 404 that a user may click on or activate to view a profile of the seller of the item.

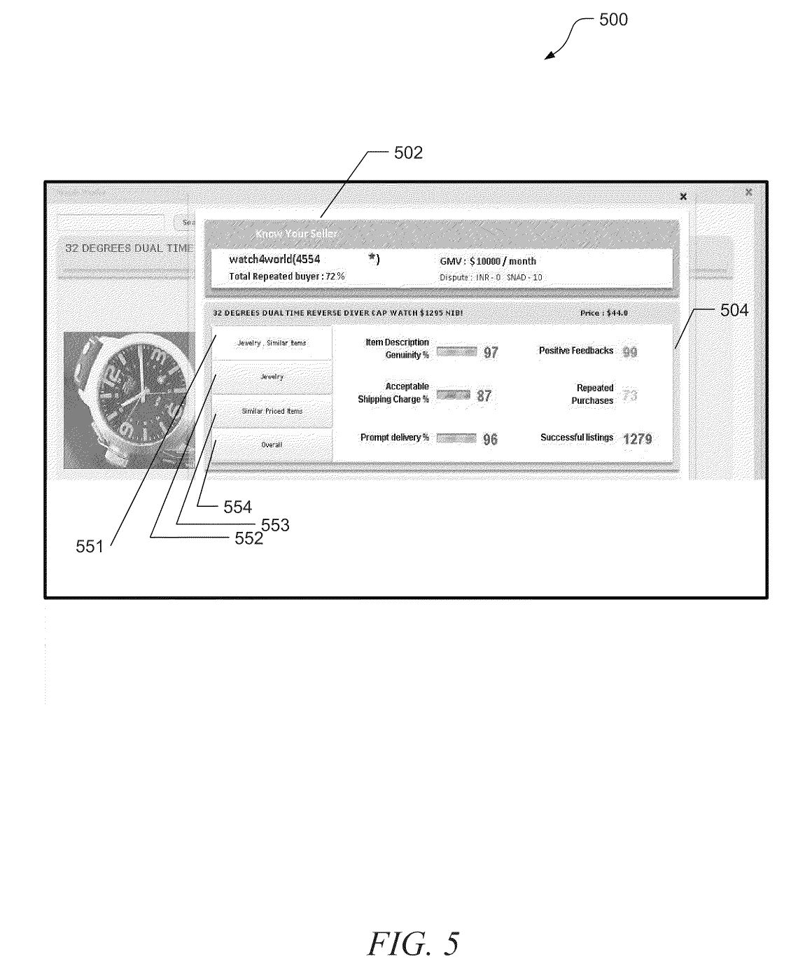

FIG. 5 is another user interface diagram, in accordance with an embodiment, that provides a profile of a seller. This user interface 500 is displayed as a consequence of a user clicking on, for example, the button region “Know Your Seller” 404 included in the user interface 400 of FIG. 4. Referring to FIG. 5, the user interface 500 includes a first window region 502 and a second window region 504 that displays various metrics associated with the seller. As depicted, window region 502 displays a total repeated buyer metric. Additionally, the window region 504 displays an item description genuineness metric, an acceptable shipping charge metric, a prompt delivery metric, a positive feedback metric, a repeated purchases metric, and a successful listings metric. As explained in more detail below, the window region 504 includes button regions 551-554 that allow the user to select various filtering criteria.

In the example of FIG. 5, the total repeated buyer metric can be calculated based on a number of unique buyers and a number of the previous transactions. As an example, the total repeated buyer metric can be defined as:

$$Total Repeated Buyer ( \% ) = ( \frac{Number of unique buyers}{Total number of previous transactions} ) 100$$

The item description genuineness metric can be calculated based on item-as-described (IAD) ratings and seller ratings. As an example, the item description genuineness metric can be defined as:

$$ItemDescriptionGenuiness ( \% ) = ( \frac{Total number of IAD ratings between 4 \text{\&} 5}{Total number of seller ratings} ) 100$$

where the IAD ratings can be an assessment of an item's condition where, for example, each IAD rating can range from 1 (low rating) to 5 (high rating).

The positive feedbacks metric can be calculated based on a number of positive feedbacks in a number of previous transactions. As an example, the positive feedbacks metric can be defined as:

$$PositiveFeedbacks ( \% ) = ( \frac{Total number of positive feedbacks}{Total number of feedbacks} ) 100$$

The acceptable shipping charge metric can be calculated based on an affinity between the shipping charge of the item and shipping charges from the previous transactions. An “affinity,” as used herein, refers to a degree of relationship or similarity between shipping charges or other items. A variety of affinity algorithms can be used to calculate the affinity between the shipping charges. Examples of affinity algorithms include Affinity-Migration allowed according to Nearest Neighbor (AMNN) and Affinity-Migration allowed Within Class (AMWC). Similarly, the prompt delivery metric can be calculated based on an affinity between a shipping time of the item and the shipping times from the previous transactions.

It should be appreciated that in various embodiments, the user may select the type of attributes used for the filtering criteria. In one embodiment, the attribute used for the filtering criteria is the category, and a user can select button region 551 to display the profile of the seller where the profile is based on previous transactions within the same category as the item at interest. In another embodiment, the attribute used for the filtering criteria is the item itself, and here, the user can select button region 552 to display a profile that is based on previous transactions of the same item at interest. In yet another embodiment, the attribute used for the filtering criteria is the price of the item, and the user can select button region 553 to display a profile that is based on previous transactions within the same price range. In still another embodiment, the retrieval of information is not based on any filtering criteria and a profile can be based on all previous transactions. The user may select button region 554 to display such a profile.

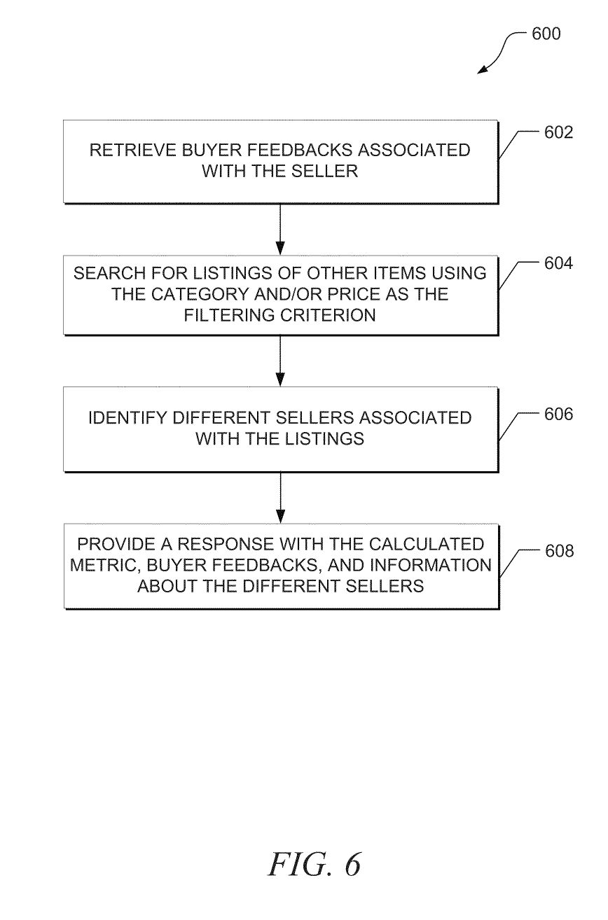

FIG. 6 is a flow diagram of a general overview of another method 600, in accordance with an alternate embodiment, for providing additional information with the metrics. In an example embodiment, the method 600 may be implemented by the buyer comments module 206 and the similar seller identification module 207, and employed in the computing device 200 of FIG. 2. In addition to calculating metrics associated with the seller, embodiments of the present invention can also display or provide other information with the metrics.

As depicted in FIG. 6, the buyer comments module, for example, can retrieve buyer feedbacks of the seller from previous transactions at 602. The buyer feedbacks can also be retrieved using, for example, the category and/or price of the item as the filtering criteria. As a result, instead of displaying all the buyer feedbacks related to a seller, which may not be very helpful to a user bidding on a particular item, a portion of the buyer feedbacks associated with a particular category and/or price range is displayed.

Additionally, in one embodiment, other similar sellers may also be displayed or provided with the metrics. Here, as depicted in FIG. 6, an additional search is conducted at 604 for listings of other items using the same category and/or price as the filtering criteria. However, these listings are not placed by or associated with the seller. Rather, these listings are placed by other, different sellers, but may be listings of items of the same category and/or price. These different sellers associated with the listings are identified at 606. The buyer feedbacks and names of the different sellers may be provided with the calculated metrics in a response at 608. Accordingly, this additional information provided with the metrics may, for example, further assist a user in deciding whether to transact with the seller.

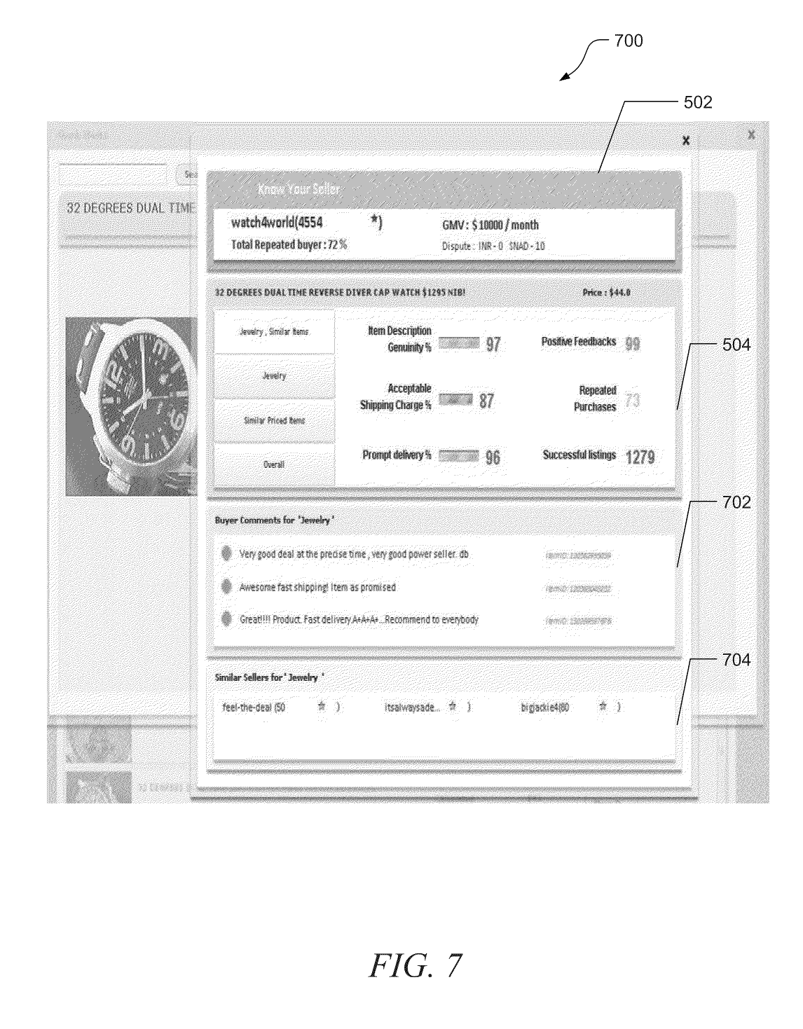

FIG. 7 is a user interface diagram showing a user interface 700, in accordance with an alternate embodiment, for providing a profile of a seller that includes metrics as well as other additional information. The user interface 700 includes window regions 502, 504, 702, and 704 that are displayed at a video display unit. As discussed above, the window regions 502 and 504 display or show various metrics associated with the seller. The window region 702, in this embodiment, additionally shows buyer feedbacks, which can be filtered based on the selected filtering criteria. For example, if the user selects the category as the filtering criteria, the window region 702 displays buyer feedbacks for previous transactions of items that are associated with the same category. In another example, if the user selects the price as the filtering criteria, the buyer feedbacks displayed in window region 702 displays buyer feedbacks of previous transactions of items that are within the same price range.

Additionally displayed with the metrics is a listing of other similar sellers (or different sellers are discussed above), which is displayed in window region 704. These different sellers listed are identified using the same filtering criteria selected by the user. For example, if the user selects the category as the filtering criteria, then window region 704 displays different sellers of items having the same category. In another example, if the user selects the price as the filtering criteria, then window region 704 displays different sellers of items that are within the same price range.

It should be appreciated that a number of suitable layouts can be designed for region layouts illustrated above as FIGS. 4, 5, and 6 do not represent all possible layout options available. The displayable appearance of the regions can be defined by any suitable geometric shape, alphanumeric character, symbol, shading, pattern, and color. Furthermore, for example, the button regions 551-554 depicted in FIG. 5, or any other region, may be omitted or dynamically assigned. It should also be appreciated that the regions can be fixed or customizable. Additionally, the computing devices may have a fixed set of layouts, utilize a defined protocol or language to define the layout, or an external structure can be reported to the computing device that defines the layout. Finally, clicking on the region of graphical user interface as discussed above may trigger code to cause the functionality described herein, such as providing the profile of a seller.

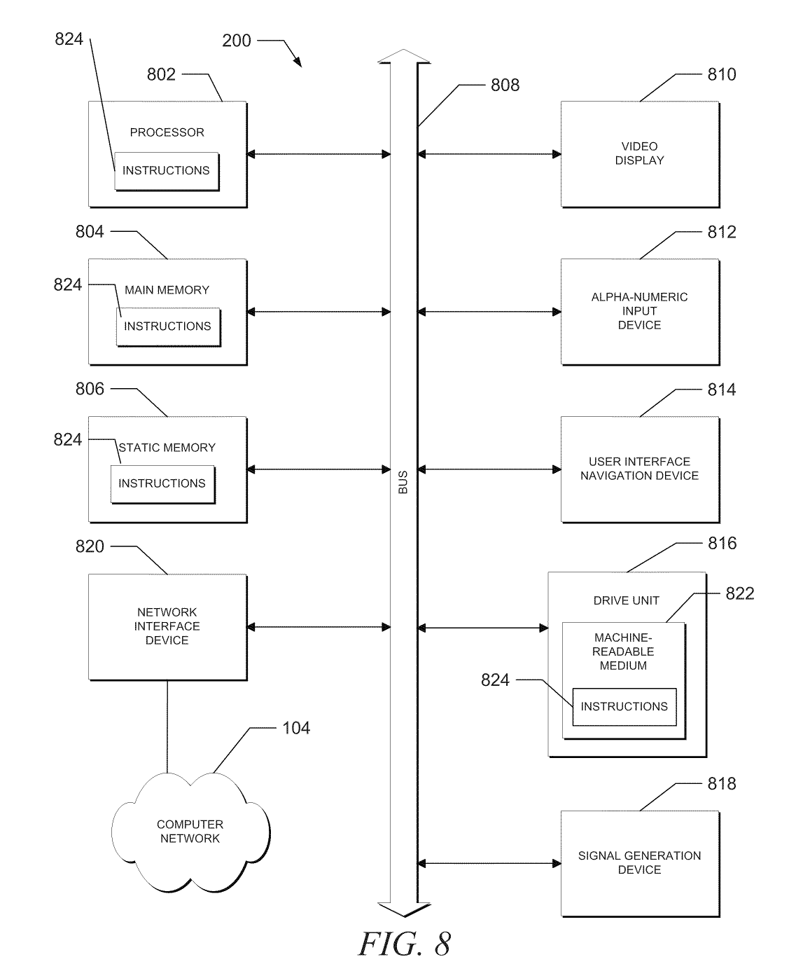

FIG. 8 is a block diagram of a machine in the example form of a computing device 200 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Embodiments may also, for example, be deployed by Software-as-a-Service (SaaS), Application Service Provider (ASP), or utility computing providers, in addition to being sold or licensed via traditional channels.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computing device 200 includes a processor 802 (e.g., a central processing unit (CPU), a graphics processing unit (GPU) or both), a main memory 804 (e.g., random access memory (a type of volatile memory)), and static memory 806 (e.g., static random access memory (a type of volatile memory)), which communicate with each other via bus 808. The computing device 200 may further include video display unit 810 (e.g., a plasma display, a liquid crystal display (LCD) or a cathode ray tube (CRT)). The computing device 200 also includes an alphanumeric input device 812 (e.g., a keyboard), a user interface (UI) navigation device 814 (e.g., a mouse), a disk drive unit 816, a signal generation device 818 (e.g., a speaker), and a network interface device 820.

The disk drive unit 816 (a type of non-volatile memory storage) includes a machine-readable medium 822 on which is stored one or more sets of data structures and instructions 824 (e.g., software) embodying or utilized by any one or more of the methodologies or functions described herein. The data structures and instructions 824 may also reside, completely or at least partially, within the main memory 804 and/or within the processor 802 during execution thereof by computing device 200, with the main memory 804 and processor 802 also constituting machine-readable, tangible media.

The data structures and instructions 824 may further be transmitted or received over a computer network 104 via network interface device 820 utilizing any one of a number of well-known transfer protocols (e.g., HTTP).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the computing device 200) or one or more hardware modules of a computer system (e.g., a processor 802 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 802 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 802 configured using software, the general-purpose processor 802 may be configured as respective different hardware modules at different times. Software may accordingly configure a processor 802, for example, to constitute a particular hardware module at one instance of time and to constitute a different hardware module at a different instance of time.

Modules can provide information to, and receive information from, other hardware modules. For example, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 802 or processor-implemented modules. The performance of certain of the operations may be distributed among the one or more processors 802, not only residing within a single machine, but deployed across a number of machines. In some example embodiments, the processor or processors 802 may be located in a single location (e.g., within a home environment, an office environment or as a server farm), while in other embodiments the processors 802 may be distributed across a number of locations.

While the embodiment(s) is (are) described with reference to various implementations and exploitations, it will be understood that these embodiments are illustrative and that the scope of the embodiment(s) is not limited to them. In general, techniques for providing profiles may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method of providing a profile of a seller, the method comprising:
receiving a request from a computing device inquiring about the profile of the seller of an item;
identifying at least one of a category or a price of the item;
retrieving information from a plurality of previous transactions associated with the seller from a data structure using the at least one of the category or the price of the item as a filtering criterion;
calculating a metric based on the information from the plurality of previous transactions; and
providing a response to the request with the metric to the computing device.

2. The method of claim 1, wherein the information includes a plurality of different attributes.

3. The method of claim 1, further comprising identifying a price range based on the price of the item, wherein the retrieval of the information uses at least one of the category of the item or the price range as the filtering criterion.

4. The method of claim 1, further comprising displaying the metric at a video display unit.

5. The method of claim 1, wherein the information from the plurality of previous transactions include a plurality of buyer feedbacks, and wherein the response includes the plurality of buyer feedbacks.

6. The method of claim 5, further comprising displaying the metric with the plurality of buyer feedbacks at a video display unit.

7. The method of claim 1, further comprising:
searching for a further listing of another item using the at least one of the category or the price of the item as the filtering criterion; and
identifying a different seller associated with the further listing,
wherein the response includes the different seller.

8. The method of claim 7, further comprising displaying the metric with the different seller at a video display unit.

9. The method of claim 1, wherein the information from the plurality of previous transactions includes a number of a plurality of unique buyers, and wherein the metric is calculated based on the number of the plurality of unique buyers and a number of the plurality of previous transactions.

10. The method of claim 1, wherein the information from the plurality of previous transactions include a plurality of item-as-described ratings and a plurality of seller ratings, wherein the metric is calculated based on the plurality of item-as-described ratings and the plurality of seller ratings.

11. The method of claim 1, wherein the information from the plurality of previous transactions includes a number of a plurality of positive feedbacks, and wherein the metric is calculated based on the number of the plurality of positive feedbacks and a number of the plurality of previous transactions.

12. A machine-readable medium that stores instructions, which, when performed by a machine, cause the machine to perform operations comprising:
receiving a request inquiring about a profile of a seller of an item;
identifying at least one of a category or a price of the item;
retrieving information from a plurality of previous transactions associated with the seller using the at least one of the category or the price of the item as a filtering criterion;
calculating a metric based on the information from the plurality of previous transactions; and
providing a response to the request with the metric.

13. The machine-readable medium of claim 12, further comprising displaying the metric at a video display unit.

14. The machine-readable medium of claim 12, wherein the information from the plurality of previous transactions include a plurality of buyer feedbacks, and wherein the response includes the plurality of buyer feedbacks.

15. The machine-readable medium of claim 12, further comprising identifying a shipping charge of the item, and wherein the information from the plurality of previous transactions includes a plurality of shipping charges, and wherein the metric is calculated based on an affinity between the shipping charge of the item and the plurality of shipping charges.

16. The machine-readable medium of claim 12, further comprising identifying a shipping time of the item, and wherein the information from the plurality of previous transactions includes a plurality of shipping times, and wherein the metric is calculated based on an affinity between the shipping time of the item and the plurality of shipping times.

17. A computing device to provide a profile of a seller, the computing device comprising:
a seller profile module to:
receive a request from a client computing device inquiring about the profile of the seller of an item;
identify at least one of a category or a price of the item;
retrieve information from a plurality of previous transactions associated with the seller from a data structure using the at least one of the category or the price of the item as a filtering criterion;
calculate a metric based on the information from the plurality of previous transactions; and
provide a response to the request with the metric to the client computing device.

18. The computing device of claim 17, further comprising a buyer comments module to retrieve the information that includes a plurality of buyer feedbacks, and wherein the response includes the plurality of buyer feedbacks with the metric.

19. The computing device of claim 17, further comprising a similar seller identification module to:
search for a further listing of another item in the data structure using the at least one of the category or the price of the item as the filtering criterion; and
identify a different seller associated with the further listing, wherein the response includes the different seller with the metric.

20. The computing device of claim 17, wherein the information from the plurality of previous transactions includes a number of a plurality of unique buyers, and wherein the metric is calculated based on the number of the plurality of unique buyers and a number of the plurality of previous transactions.

21. The computing device of claim 17, wherein the seller profile module is to further identify a shipping charge of the item, wherein the information from the plurality of previous transactions includes a plurality of shipping charges, and wherein the metric is calculated based on an affinity between the shipping charge of the item and the plurality of shipping charges.
